(19) United States
(12) Patent Application Publication
(10) Pub. No.: US 2006/0218081 A1
(43) Pub. Date: Sep. 28, 2006

(54) System and method for document management

(75) Inventors: Samuel David Baker, Lewisville, TX (US); Mitchell Garnaat, Victor, NY (US); Dawn M. Williams-Fuller, Penfield, NY (US)

Correspondence Address: PEPPER HAMILTON LLP, ONE MELLON CENTER, 50TH FLOOR, 500 GRANT STREET, PITTSBURGH, PA, 15219, US

(73) Assignee: Xerox Corporation

(21) Appl. No.: 11/087,436

(22) Filed: Mar. 23, 2005

(51) Int. Cl. G06Q 40/00; G06F 17/00; G06F 15/00

(52) U.S. Cl. 705/39; 715/500

(57) ABSTRACT

A heuristic method and system for document management are disclosed. A document management system may specify transaction constraints for various transaction types. The system may then receive a document containing information pertaining to a transaction. The information may be stored and transaction requirements based on a transaction constraint and the stored information may be determined. A representation of the transaction requirement may be presented to a transaction participant. Further, the system may send a notification to the transaction participant based on the transaction requirement. A document management system may include a document repository having an intelligent folder that can store a document, a constraint solver for determining document requirements, a graphical user interface, and a notification system.

### TECHNICAL FIELD

The disclosed embodiments generally relate to methods and systems for managing documents. More particularly, the disclosed embodiments relate to methods and systems for managing documents received from transaction participants and proactively determining which unsubmitted documents are likely to contain information that is required to complete a transaction.

### BACKGROUND

A business transaction can be a document-intensive process that depends upon the assembly and completion of documents within a determined time frame. For example, mortgage closings require a large number of documents to be assembled on behalf of the many constituents in the process. Alternately, a lender could require a substantial amount of supporting documentation from the applicant when determining whether to fund a particular loan. Other document-intensive transactions may include account formations, such as for a wealth management account; stock offerings; corporate mergers and acquisitions; due diligence reviews; document discovery, such as during litigation; and the like. The specific type of documents that are required for a given transaction depend on a number of factors, such as a type of loan product, the income and credit worthiness of the applicant, the value of the property, the type of security to be purchased, etc. Specifying document requirements for a transaction and tracking them throughout the transaction is a complex process that is typically performed manually or with substantial human interaction.

Some currently available products and services attempt to simplify this process by digitizing paper documents and storing them in a document management repository. An exemplary document management system is described in U.S. Pat. No. 6,868,424 to Jones et al., which is incorporated herein by reference in its entirety. Some systems provide further automation in the form of pre-programmed workflow notification systems that distribute discrete work units to participants but do not necessarily inform all transaction participants upon the arrival of new documents related to a particular transaction. Nor do they inform participants of what document requirements are unfulfilled at any particular time for any particular transaction. These systems having a predetermined process provide inadequate information regarding the complete document requirements related to a transaction and cannot dynamically adjust document requirements for the transaction based on new information regarding the applicant or the subject matter of the transaction. This can cause significant delays and rework in the processing of these transactions.

Moreover, the process of determining which documents are needed for a particular transaction or type of transaction can be complex and overwhelming. A lack of proper documentation impacts factors such as time to revenue, regulatory compliance, customer satisfaction, and productivity.

Additionally, any particular business can simultaneously perform hundreds of different transactions having differing document collection requirements. Such requirements pose additional layers of complexity and unpredictability.

Other electronic systems provide a simple mechanism for virtual folders to receive and manage documents related to loans. However, they are based on static descriptions of document requirements and do not provide a user with the flexibility to easily tailor the folder's expected documents to the exact requirements of the transaction or to quickly change the requirements based on updated information related to the transaction.

Accordingly, a need exists for a method and system of document management capable of defining and updating a list of required documents, tracking the receipt of such documents, and notifying transaction participants of the receipt of such documents while allowing for increased productivity and reduced cycle time.

A further need exists for a method and system of document management that notifies the transaction participants as to which documents must be updated based on newly received information and/or which documents have yet to be received.

A further need exists for a method and system of document management that proactively informs transaction participants of deadlines, impending deadlines, and new document requirements based on information received in previous document submissions.

The present disclosure attempts to solve one or more of the above-listed problems.

### SUMMARY

Before the present methods, systems and materials are described, it is to be understood that this disclosure is not limited to the particular methodologies, systems and materials described, as these may vary. It is also to be understood that the terminology used in the description is for the purpose of describing the particular versions or embodiments only, and is not intended to limit the scope.

It must also be noted that as used herein and in the appended claims, the singular forms “a,” “an,” and “the” include plural references unless the context clearly dictates otherwise. Thus, for example, reference to a “document” is a reference to one or more documents and equivalents thereof known to those skilled in the art, and so forth. Unless defined otherwise, all technical and scientific terms used herein have the same meanings as commonly understood by one of ordinary skill in the art. Although any methods, materials, and devices similar or equivalent to those described herein can be used in the practice or testing of embodiments of the invention, the preferred methods, materials, and devices are now described. All publications mentioned herein are incorporated by reference. Nothing herein is to be construed as an admission that the invention is not entitled to antedate such disclosure by virtue of prior invention.

In an embodiment, a method for document management may include specifying a transaction constraint for a transaction, receiving a document including information pertaining to a transaction, storing the information, determining a transaction requirement based on the transaction constraint and the stored information, presenting a representation of the transaction requirement, and sending a notification to a transaction participant based on the transaction requirement.

In an embodiment, a system utilized for document management may include a document repository having an intelligent folder, a constraint solver, a graphical user interface, and a notification system. The document repository may store a document in the intelligent folder.

### BRIEF DESCRIPTION OF THE DRAWINGS

Aspects, features, benefits and advantages of the embodiments of the present invention will be apparent with regard to the following description, appended claims and accompanying drawings where:

FIG. 1 depicts a flow diagram for an exemplary method of managing documents for a transaction according to an embodiment.

FIG. 2 depicts an exemplary system for managing documents according to an embodiment.

FIG. 3 is a block diagram of exemplary hardware that may be used to contain and/or implement the program instructions of a system embodiment.

### DETAILED DESCRIPTION

The methods and systems disclosed herein may include a document repository for collecting documents from transaction participants, a constraint solver for determining which documents are required for a transaction, a user interface for communicating document requirements and document status for the transaction, and a set of application messages used for communication between the document management system and any other software application with which communication is required.

A document management system may be used to store documents and folders in a central location. A document may include a physical or electronic source of information. A document may contain information pertaining to, for example, a transaction or a proposed transaction. The document may be submitted by a transaction participant to the document management system to satisfy a document requirement for the transaction or proposed transaction. A transaction participant may be a party to the transaction and/or a representative of a party to the transaction, such as an attorney, a financial advisor, and/or another agent. In an embodiment, a document may include one or more metatags, which delimit information in an electronic document. For example, the electronic document may include a transaction participant metatag delimiting a field denoting the name of the transaction participant. Information associated with a metatag is referred to herein as metadata. In an embodiment, physical documents may be converted to electronic documents prior to being incorporated into the document management system.

An intelligent folder, or simply a folder, may include one or more documents. A folder may pertain to a particular transaction or a portion of a transaction. In an embodiment, the intelligent folder may receive documents pertaining to the transaction with which the folder is associated.

An intelligent folder may further include a plurality of transaction constraints for the transaction. The transaction constraints may define, for example, a document to be received, a date and/or time by which a document and/or other information should be or must be received, a period of time for which a particular document is valid, a date and/or time by which all documents and/or other information must be received, a date and/or time by which the transaction must be completed, and/or information required to complete the transaction to which the intelligent folder pertains. Transaction constraints may be defined for each of a plurality of transaction types. In an embodiment, a set of transaction constraints pertaining to a particular transaction type may be automatically assigned to the intelligent folder pertaining to the transaction when the folder is created.

The intelligent folder may automatically update its knowledge of the transactions as a new document is received. For example, the document may be added to the intelligent folder. The document may be processed to determine the information contained within the document by, for example, examining metadata and/or other information within the document. Based on the information contained within the document requests, one or more transaction constraints and/or more or more document requirements may be satisfied or modified. Document requests may be automatically updated based on the satisfied or modified transaction constraints and/or document requirements. An intelligent folder may initiate one or more document request notifications based on one or more document requirements. An intelligent folder may request a notification in advance of the due date for a particular document. In addition, a notification may be generated based on a modification to a transaction constraint.

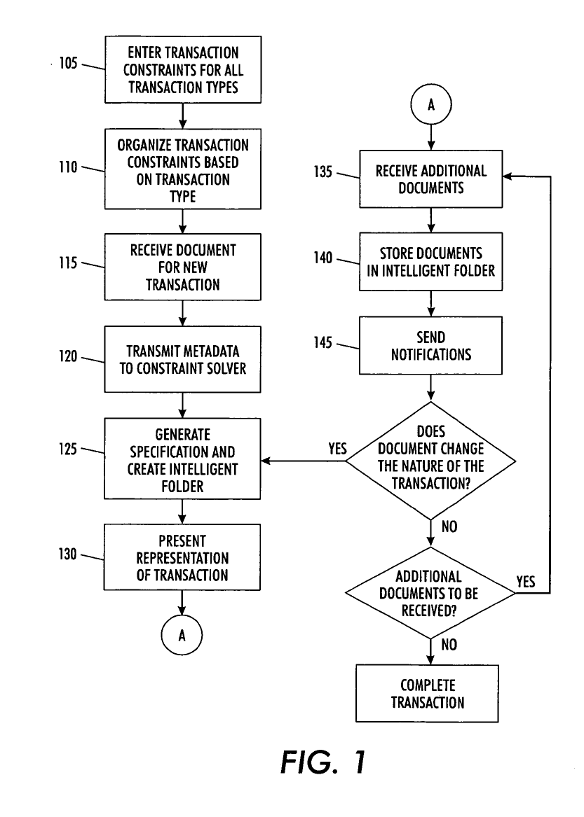

FIG. 1 depicts a flow diagram for an exemplary method of managing documents for a transaction according to an embodiment. Initially, transaction requirements associated with a plurality of transaction types may be entered 105 as transaction constraints into one or more data files. Each transaction constraint may define a particular requirement for at least one transaction type. In an embodiment, a transaction constraint may be assigned to one or more transaction types to which it pertains. For example, a transaction constraint requiring the name of a transaction participant may be assigned to a plurality of transaction types. Other transaction constraints may include, for example, financial limitations, geographic limitations, or time-based limitations.

Transaction constraints may be organized 110 as a plurality of transaction constraint sets. In an embodiment, each transaction constraint set may correspond to a particular transaction type. In an embodiment, each transaction constraint set may be organized in a separate data file.

A document pertaining to a new transaction or proposed transaction may then be received 115. The document may contain, for example, metatags and metadata associated with the metatags. The metadata and/or other information from the document may be extracted to determine the transaction type to which the document pertains. Such information may include, without limitation, a name and/or other identifying information for a transaction participant, a representation of a transaction type, and/or information pertaining to the subject matter of the transaction (such as a location of a real estate property, a name of a company to be acquired, and the like).

The method by which information is extracted from the document may depend on the format of the document. In an embodiment, if the document is in a physical format, the document may be converted to an electronic format. In an embodiment, a document in electronic format may have one or more metatags inserted. In an embodiment, extraction of information from an electronic document with metatags may include copying the metadata associated with one or more of the metatags and/or other information into one or more metadata variables within an intelligent folder. Alternate and/or additional methods may also be used within the scope of this disclosure.

At least a portion of the extracted information may be transmitted 120 to a constraint solver. The constraint solver may use the extracted information to provide a specification of the type of documents required to satisfy the transaction constraints for the transaction. In an embodiment, the specification provided by the constraint solver may include a transaction constraint set for a particular transaction type with which the information is identified. In an embodiment, the specification may further include information pertaining to deadlines and life spans for particular documents. A deadline may be a date by which a particular document should be or must be received in the intelligent folder to further the progress of the transaction. A life span may be the amount of time for which a document supplied to the document management system is valid. For example, a credit report submitted for a loan application may have a life span of four months. If the transaction has not been completed within the life span, the document management system may request an updated version of the document.

The specification provided by the constraint solver may be used to order the creation 125 of an intelligent folder in a document repository. The intelligent folder may logically organize all documents related to the transaction to which the information pertains. In an embodiment, one or more metadata variables associated with the intelligent folder may be assigned values based on the information received by the document management system.

Based on one or more of the unsatisfied transaction constraints, unsatisfied document requests, and unassigned metadata variables in an intelligent folder, the document management system may present 130 a representation of the documents, transaction constraints and/or variables associated with a transaction. The representation may be presented on a display, in a hard copy format, such as on paper, and/or via any other device for displaying information. In an embodiment, the document management system may display all documents that have not been submitted for a particular transaction. In an alternate embodiment, all documents required for a transaction and the current state of each document may be displayed. In an embodiment, one, more or all of the transaction constraints, metadata variables, and/or the states of the transaction constraints and/or metadata variables may be displayed. In an embodiment, a graphical representation may be displayed, such as a timeline denoting when the particular document, transaction constraint and/or metadata variable should be or must be completed.

As the document management system receives 135 documents satisfying the document requests and/or transaction constraints, the documents may be stored 140 in the intelligent folder corresponding to the transaction to which the documents pertain. Notifications may also be sent 145 via, for example, electronic mail to transaction participants. In addition, if a due date for a document arrives (or is imminent) and the document is not within the intelligent folder, the document management system may send a notification via, for example, electronic mail to the transaction participants. In an embodiment, such notifications may be sent proactively to enable a transaction participant to submit the document prior to the deadline.

If a document or other information is received 135 during the pendency of a transaction that changes the nature of the transaction, the document management system may transmit 120 such information to the constraint solver. The constraint solver may use the information to determine a modified specification for the transaction. The modified specification may be used to modify 125 the intelligent folder by modifying, removing, and/or adding one or more document requirements, one or more transaction constraints, and/or one or more metadata variables. The modified specification may further be compared with previously received documents located within the intelligent folder to determine whether a new representation of the transaction may be generated 130 and whether one or more notifications may be sent to the transaction participants.

In an embodiment, a mortgage transaction may be performed. A user may define transaction constraints for one or more mortgage transaction types. For example, the user may specify that only documents showing a clear chain of title will be accepted for mortgage approval. The transaction constraints may be entered into one or more data files. Each data file may correspond to a particular type of mortgage transaction and may contain the transaction constraints pertaining to the mortgage transaction.

When a document is received, a determination may be made as to whether the document pertains to a previously existing transaction or a new transaction. For example, if the document is determined to be a mortgage application, a determination may be made that the document pertains to a new transaction. In an embodiment, the document may be received in an electronic format. Metadata and/or other information from the document may be extracted to determine the mortgage transaction type to which the document pertains. For example, in the case of a title search report, encumbrances shown on the mortgage document may be stored as data.

At least a portion of the extracted information may be transmitted to a constraint solver. The constraint solver may use the extracted information and the determined mortgage transaction type to provide a specification of the documents and/or type of documents required to satisfy the transaction constraints for the particular mortgage transaction. In an embodiment, the specification provided by the constraint solver may include a transaction constraint set for the particular mortgage transaction type with which the information is identified. In an embodiment, the specification may further include information pertaining to deadlines and life spans for particular documents, such as credit reports and/or interest rate agreements. For example, if the transaction constraint requires a clear chain of title and the document shows an encumbrance, a transaction requirement may be generated that states that the encumbrance must be removed before the mortgage will be approved. In an additional example, a time limit may be placed on this requirement.

Based on the transaction constraint set, an intelligent folder may be created in a document repository. The intelligent folder may organize the documents for the mortgage transaction. Based on the information in the intelligent folder, the document management system may provide information to the transaction participants pertaining to a list of documents that are required, have lapsed, and/or will lapse in the near future. For example, a mortgage loan application, property inspection reports and/or surveys, title search reports, consumer credit reports, land value estimates, certificates of insurance, a deed, and the like may be required in order to consummate the mortgage transaction.

As the document management system receives documents satisfying the document requests and/or transaction constraints for the mortgage transaction, the documents may be stored in the intelligent folder corresponding to the mortgage transaction. Notifications of required documents and/or received documents may be sent via, for example, electronic mail to transaction participants.

If a document or other information is received during the pendency of the mortgage transaction that changes the nature of the transaction (such as a document changing the interest rate or an updated credit report), the document management system may transmit such a document and/or information to the constraint solver. The constraint solver may use the document and/or information to modify the specification for the mortgage transaction. The modified specification may modify, remove, and/or add document requirements, transaction constraints, and/or other information to the intelligent folder for the mortgage transaction. The modified specification may be compared with previously received documents located within the intelligent folder to determine whether a new representation of the mortgage transaction should be generated and whether one or more notifications should be sent to the transaction participants.

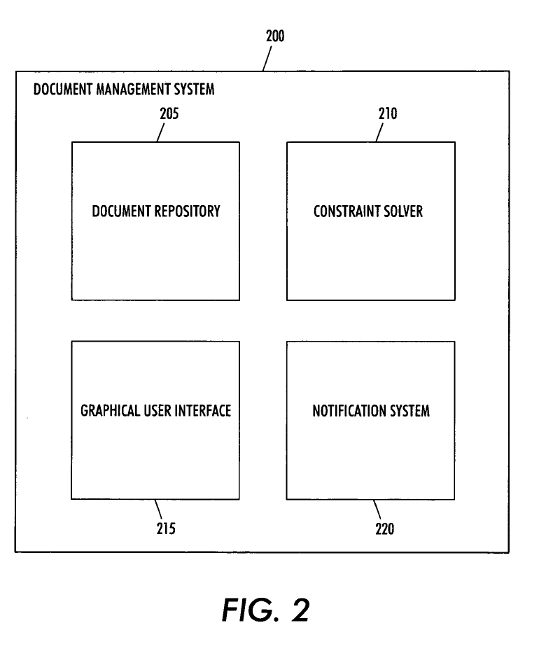

FIG. 2 depicts an exemplary system for managing documents according to an embodiment. As shown in FIG. 2, the document management system 200 may include a document repository 205, a constraint solver 210, a graphical user interface 215 and a notification system 220.

The document repository 205 may be capable of storing arbitrary documents and related metadata. The document repository 205 may be a standard off-the-shelf document management product. In an embodiment, the document repository 205 may include document version support, document access control, rendition control, the assignment of custom properties to documents, and/or a program interface for accessing and manipulating documents within the document repository 205. In an embodiment, the document repository may include one or more intelligent folders. Each intelligent folder may be assigned to a transaction and may incorporate one or more documents, one or more transaction constraints, and/or one or more metadata variables.

The constraint solver 210 may provide a mechanism for specifying one or more document constraints in a declarative manner. For example, the document constraints may state that a particular document is required, a particular deadline must be met, and/or a particular life span is associated with a document. The constraint solver 210 may further be capable of solving satisfaction-type problems based on the specified document constraints. A satisfaction-type problem may include resolving whether a particular document has been submitted, a particular deadline has been met, and/or a particular life span for a document is still active. In an embodiment, multiple satisfaction-type queries may be determined with respect to a particular document constraint.

The graphical user interface 215 may impose a user interface metaphor designed to support a particular transaction type or a general user interface metaphor for transactions generally. In an embodiment, the graphical user interface 215 may represent an intelligent folder. The intelligent folder may seek to model a paper-based process for the given transaction while managing documents in an electronic form. In an embodiment, the graphical user interface 215 may be Internet-based to permit access to the document management system 200 by transaction participants from remote locations.

The notification system 220 may be capable of notifying transaction participants, other computer applications and/or other users of the document management system 200 about unfulfilled document requirements, unsatisfied transaction constraints, and the like. In an embodiment, the notification system 220 may further provide notification regarding non-events, such as lapsed deadlines, expired life spans, and the like. In an embodiment, the notification system 220 may notify transaction participants by electronic means, such as electronic mail. In an embodiment, the notification system 220 may notify transaction participants by messages sent to a computer application.

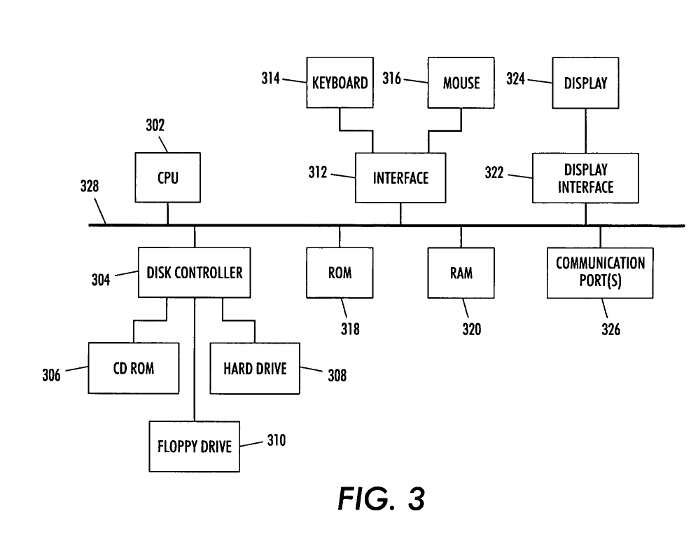

FIG. 3 is a block diagram of exemplary hardware that may be used to contain and/or implement the program instructions of a system embodiment. Referring to FIG. 3, a bus 328 serves as the main information highway interconnecting the other illustrated components of the hardware. CPU 302 is a central processing unit of the system, performing calculations and logic operations required to execute a program. Read only memory (ROM) 318 and random access memory (RAM) 320 constitute exemplary memory devices.

A disk controller 304 may interface with one or more optional disk drives to the system bus 328. These disk drives may be external or internal memory keys, zip drives, flash memory devices, floppy disk drives or other memory media such as 310, CD ROM drives 306, or external or internal hard drives 308. As indicated previously, these various disk drives and disk controllers are optional devices.

Program instructions may be stored in the ROM 318 and/or the RAM 320. Optionally, program instructions may be stored on a computer readable medium such as a floppy disk or a digital disk or other recording medium, a communications signal or a carrier wave.

An optional display interface 322 may permit information from the bus 328 to be displayed on the display 324 in audio, graphic or alphanumeric format. Communication with external devices may optionally occur using various communication ports 326. An exemplary communication port 326 may be attached to a communications network, such as the Internet or an intranet.

In addition to the standard computer-type components, the hardware may also include an interface 312 which allows for receipt of data from input devices such as a keyboard 314 or other input device 316 such as a remote control, pointer and/or joystick. A display including touch-screen capability may also be an input device 316. An exemplary touch-screen display is disclosed in U.S. Pat. No. 4,821,029 to Logan et al., which is incorporated herein by reference in its entirety.

An embedded system may optionally be used to perform one, some or all of the operations of the methods described below. Likewise, a multiprocessor system may optionally be used to perform one, some or all of the methods described below.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method for document management, the method comprising:
specifying a transaction constraint for a transaction;
receiving a document, wherein the document comprises information pertaining to a transaction;
storing data representative of at least a portion of the information;
determining a transaction requirement based on the transaction constraint and the stored information;
presenting a representation of the transaction requirement; and
sending a notification to a transaction participant based on the transaction requirement.

2. The method of claim 1, further comprising:
receiving a second document; and
updating the transaction requirement based on the second document.

3. The method of claim 1, further comprising:
selecting a transaction type based on the stored information.

4. The method of claim 3, further comprising:
receiving a second document, wherein the second document comprises second information;
updating the transaction type based on the second information.

5. The method of claim 1 wherein the transaction comprises one or more of a loan, a mortgage closing, an account formation, a stock offering, a merger, an acquisition, a due diligence review, and document discovery.

6. The method of claim 1 wherein the document comprises an electronic document.

7. The method of claim 1 wherein the document comprises metatags.

8. The method of claim 1 wherein the information comprises metadata.

9. The method of claim 1 wherein the transaction requirement comprises one or more of a document, a deadline for a document, and a lifespan for a document.

10. The method of claim 1 wherein the transaction requirement relates to a mortgage application.

11. The method of claim 1 wherein the transaction requirement comprises receiving one or more of a mortgage loan application, a property inspection report, a property survey, a title search report, a consumer credit report, a land value estimate, a certificate of insurance, and a deed.

12. The method of claim 1 wherein the representation comprises a graphical representation.

13. The method of claim 1 wherein the representation comprises the transaction requirement and a status for the transaction requirement.

14. The method of claim 1 wherein the notification comprises an electronic mailing.

15. The method of claim 1 wherein sending a notification comprises notifying a transaction participant of one or more of a deadline for an expected document, an expired lifespan for a document, a document requirement, a transaction constraint, and a metadata variable.

16. A system for document management, comprising:
a document repository having an intelligent folder, wherein the document repository stores a document in the intelligent folder;
a constraint solver;
a graphical user interface; and
a notification system.

17. The system of claim 16 wherein the document repository comprises one or more of version control for the document, document access control, rendition control for the document, an assignment of custom properties to the document, and a program interface for accessing and manipulating the document.

18. The system of claim 16 wherein the constraint solver determines one or more transaction constraints for a transaction based on the document.

19. The system of claim 16 wherein the graphical user interface is Web-based.

20. The system of claim 16 wherein the notification system notifies a transaction participant of one or more of an unfulfilled document requirement, an unsatisfied transaction constraint, a lapsed deadline, and an expired life span.

21. The system of claim 16 wherein the notification system notifies transaction participants via electronic mail.

22. The system of claim 16 wherein the notification system notifies transaction participants via computer messages sent to a computer application.
